(19) United States
(12) Patent Application Publication
(10) Pub. No.: US 2014/0377548 A1
(43) Pub. Date: Dec. 25, 2014

(54) RETORTABLE EASY OPENING SEALS FOR FILM EXTRUSION

(71) Applicants: Cyrille Billouard, Zuerich (CH); Shaun Parkinson, Tarragona (ES); Xiaosong Wu, Sugar Land, TX (US); John W. Garnett, Omaha, NE (US)

(72) Inventors: Cyrille Billouard, Zuerich (CH); Shaun Parkinson, Tarragona (ES); Xiaosong Wu, Sugar Land, TX (US); John W. Garnett, Omaha, NE (US)

(73) Assignee: Dow Global Technologies LLC, Midland, MI (US)

(21) Appl. No.: 14/364,333

(22) PCT Filed: Dec. 27, 2012
(86) PCT No.: PCT/US2012/071825

§ 371 Date: Jun. 11, 2014

Related U.S. Application Data
(60) Provisional application No. 61/580,815, filed on Dec. 28, 2011.

(51) Int. Cl. B32B 7/06; B32B 27/32; B32B 27/08

(52) U.S. Cl. CPC B32B 7/06; B32B 27/08; B32B 27/32; B32B 2274/00; B32B 2307/31; B32B 2307/748; B32B 2307/552
USPC 428/349

(57) ABSTRACT

The multilayer film comprises a first outer layer which is heat sealable. The first outer layer comprises from 95 to 100 percent (by weight of the first outer layer) of a first polymer, said first polymer being derived from propylene monomer and optionally one or more comonomers selected from the group consisting of ethylene and C4-C8 alpha olefins. The first polymer should have a melting point of at least 125 C. The multilayer film further comprises an inner portion adjacent to the first outer layer. The inner portion may be a single layer or may comprise several layers. At least one layer of the inner portion comprises an elastomeric propylene based polymer (“EPBP”). Further at least one layer of the inner portion comprises a second polymer, wherein the second polymer is selected from the group consisting of high pressure low density polyethylene, high density polyethylene, ethylene acrylic acid copolymers, ethylene (meth)acrylic acid copolymers and combinations thereof. The second polymer may be together with the EPBP in the same layer or may be in a separate layer. It is also contemplated that the inner portion may optionally comprise one or more additional layers, which may or may not contain EPBP or the second polymer. The multilayer film further comprises a second outer layer arranged so that the inner portion is encapsulated between the first outer layer and the second outer layer. The second outer layer comprises a third polymer, wherein said third polymer is selected from the group consisting of homopolymer polypropylene, random copolymer polypropylene and impact copolymer polypropylene and blends thereof.

### CROSS REFERENCE TO RELATED APPLICATIONS

This application claims priority from U.S. Provisional Application No. 61/580,815, filed Dec. 28, 2011.

### FIELD OF THE INVENTION

The invention relates to a polyolefin-based heat sealable, retortable easy opening seal. The invention also relates to methods of making and using the heat sealable, retortable easy opening seal.

### BACKGROUND AND SUMMARY OF THE INVENTION

Heat sealable and easy-opening films are employed on a large scale for temporarily closing containers that include, for example, food products. During use, a consumer tears away the peelable film. To gain consumer acceptance, a number of characteristics associated with a heat sealable and peelable film are desired.

Heat sealable films must be capable of being sealed upon the application of heat. During typical sealing processes, the backing or web layer of the film comes into direct contact with a heated surface such as a sealing jaw. Heat is thus transferred through the backing layer of the film to melt and fuse the inner sealant layer to form a seal. Accordingly the backing layer generally has a higher melting temperature than the inner sealant layer so that the backing layer of the film does not substantially melt and therefore does not stick to the heated surface.

Moreover, if the package to be sealed is designed to contain food, particularly unrefrigerated food, then in order for the product to have an acceptable shelf life (for example at least six months) the seal should be capable of surviving a retort operation. A typical retort process subjects the sealed package to a temperature of 212° F. to 275° F. for 20 to 60 minutes or even up to 100 minutes, depending on the size of the container. During the retort process, gases are generated within the package and pressure increases greatly. Although the retort system may include an over pressure to help balance the package internal pressures, the net result will still be a pressurized package during retorting. Thus, the films used to seal the container must be sufficiently strong to withstand the increased internal pressure and the elevated temperatures.

Because of the need to withstand such pressures, seals used in retort applications are typically difficult to open at room temperature using average manual force. It would be desirable to have a heat sealable film which could withstand the conditions of retort applications yet still be easily opened manually by a consumer. The force required to pull a seal apart is called “seal strength” or “heat seal strength” which can be measured in accordance with ASTM F88-94. The desired seal strength varies according to specific end user applications. For flexible packaging applications, such as cereal liners, snack food packages, cracker tubes and cake mix liners, the seal strength desired is generally in the range of about 1-9 pounds per inch. For example, for easy-open cereal box liners, a seal strength in the range of about 2-3 pounds per inch is commonly specified, although specific targets vary according to individual manufactures requirements. In addition to flexible packaging application, a sealable and peelable film can also be used in rigid package applications, such as lids for convenience items (e.g., snack food such as puddings) and medical devices. Typical rigid packages have a seal strength of about 1-5 pounds per inch. The seal layer can be on the lid or on the container or both.

Another desired property for the heat-sealable films is adequate hot tack”. After the film is removed from contact with the heated surface and/or the retort process, the film is cooled to room temperature. Before the inner sealant layer is cooled to room temperature, it should be able to maintain its seal integrity. The ability of an adhesive or sealant layer to resist creep of the seal while it is still in a warm or molten state is generally referred to as “hot tack.” To form a good seal, the hot tack of the sealable and peelable film should be adequate.

It is also desirable to have a low heat seal initiation temperature which helps to ensure fast packaging line speeds and a broad sealing window which could accommodate variability in process conditions, such as pressure and temperature. A broad sealing window also enables high speed packaging of heat sensitive products, as well as, provides a degree of forgiveness for changes in packaging or filling speeds.

Additional desired characteristics for heat sealable films include a low coefficient of friction and good abuse resistance. A low coefficient of friction ensures that the sealant layer can be processed smoothly and efficiently on fabrication and packaging equipment and is particularly important for vertical form-fill-and-seal packaging. Good abuse resistance and toughness is desired, for example, in cereal box liners to withstand tears and punctures from irregularly-shaped, rigid cereals. Additional characteristics include taste and odor performance and barrier or transmission properties.

It has been discovered that certain multilayer films will achieve one or more of the above stated goals, and thus be particularly well suited for retort applications. The multilayer film comprises a first outer layer which is heat sealable. The first outer layer comprises from 95 to 100 percent (by weight of the first outer layer) of a first polymer, said first polymer being derived from propylene monomer and optionally one or more comonomers selected from the group consisting of ethylene and C₄-C₈ alpha olefins. The first polymer should have a melting point of at least 125° C. The multilayer film further comprises an inner portion adjacent to the first outer layer. The inner portion may be a single layer or may comprise several layers. At least one layer of the inner portion comprises an elastomeric propylene based polymer (“EPBP”). Further at least one layer of the inner portion comprises a second polymer, wherein the second polymer is selected from the group consisting of high pressure low density polyethylene, high density polyethylene, ethylene acrylic acid copolymers, ethylene (meth) acrylic acid copolymers and combinations thereof. The second polymer may be together with the EPBP in the same layer or may be in a separate layer. It is also contemplated that the inner portion may optionally comprise one or more additional layers, which may or may not contain EPBP or the second polymer. The multilayer film further comprises a second outer layer arranged so that the inner portion is encapsulated between the first outer layer and the second outer layer. The second outer layer comprises a third polymer, wherein said third polymer is selected from the group consisting of homopolymer polypropylene, random copolymer polypropylene and impact copolymer polypropylene and blends thereof.

### BRIEF DESCRIPTION OF DRAWINGS

FIG. 1 is a schematic showing the theorized burst cohesive failure mechanism of certain embodiments of the present invention.

FIG. 2 is a schematic showing the theorized burst delamination mechanism of certain embodiments of the present invention.

### DETAILED DESCRIPTION OF THE INVENTION

The term “polymer”, as used herein, refers to a polymeric compound prepared by polymerizing monomers, whether of the same or a different type. The generic term polymer thus embraces the term “homopolymer”, usually employed to refer to polymers prepared from only one type of monomer as well as “copolymer” which refers to polymers prepared from two or more different monomers.

“Melt strength” which is also referred to in the relevant art as “melt tension” is defined and quantified herein to mean the stress or force (as applied by a wind-up drum equipped with a strain cell) required to draw a molten extrudate at a haul-off velocity at which the melt strength plateaus prior to breakage rate above its melting point as it passes through the die of a standard plastometer such as the one described in ASTM D1238-E. Melt strength values, which are reported herein in centi-Newtons (cN), are determined using a Gottfert Rheotens at 190° C.

The present invention relates to a multilayer film particularly well-suited for heat seals used in retort applications. The multilayer film comprises a first outer layer which is heat sealable. The first outer layer comprises from 95 to 100 percent (by weight of the first outer layer) of a first polymer, said first polymer being derived from propylene monomer and optionally one or more comonomers selected from the group consisting of ethylene and C₄-C₈ alpha olefins. Such first polymer can be homopolymer polypropylene but is more preferably a random copolymer of units derived from propylene and from 0.1 to 10% of units derived from ethylene and/or one or more alpha-olefin monomers having from four to eight carbon atoms. The limits as to the amount of comonomer will depend in part upon the polymerization method, including catalyst selection (single site, metallocene, post metallocene, Ziegler-Natta, etc.) chosen. The first polymer should have a melt flow rate (“MFR”) of from 0.5 to 25 g/10 min (as determined according to ASTM D1238, 2.16 kg, 230° C.), more preferably from 2 to 1 g/10 min. The particular MFR selected will depend in part on the intended fabrication methods such as blown film, extrusion coating, sheet extrusion, or cast film processes. The first polymer may have a density (as determined according to ASTM D-792) from 0.890 to 0.902 g/cm³. The first polymer should have a melting point (as determined according to the DSC method described below) of at least 125° C., more preferably at least 130° C. or 135° C.

The first outer layer may optionally contain up to 5 percent (by weight of the first outer layer) of an elastomeric propylene-based polymer or “EPBP”. EPBPs comprise at least one copolymer with at least about 50 weight percent of units derived from propylene and at least about 5 weight percent of units derived from a comonomer other than propylene, preferably ethylene. Suitable elastomeric propylene based polymers include the propylene based plastomers or elastomers (“PBPE's”) taught in WO03/040442, and WO/2007/024447, each of which is hereby incorporated by reference in its entirety. Of particular interest for use in the present invention are EPBP's having a molecular weight distribution of less than 3.5, including reactor grade PBPE's. The term “reactor grade” refers to a polyolefin resin whose molecular weight distribution (MWD) or polydispersity has not been substantially altered after polymerization. The term molecular weight distribution or “MWD” is defined as the ratio of weight average molecular weight to number average molecular weight (M_{w}/Mₙ). M_{w} and Mₙ are determined according to methods known in the art using conventional GPC. The preferred EPBP will have a heat of fusion (as determined using the DSC method described in WO2007/024447) less than about 90 Joules/gm, preferably less than about 70 Joules/gm, more preferably less than about 50 Joules/gm. When the preferred comonomer ethylene is used, the EPBP has from about 3 to about 15 percent of ethylene, or from about 5 to about 14 percent of ethylene, or about 7 to 12 percent ethylene, by weight of the EPBP.

Other comonomers which may be used instead of, or in addition to the preferred ethylene comonomer in the EPBP include C₄₋₂₀ α-olefins, C₄₋₂₀ dienes, a styrenic compounds and the like. Preferably the comonomer is at least one of ethylene and a C₄₋₁₂ α-olefin such as 1-hexene or 1-octene. Preferably, the remaining units of the copolymer are derived only from ethylene. The amount of comonomer other than ethylene in the propylene based elastomer or plastomer is a function of, at least in part, the comonomer and the desired heat of fusion of the copolymer. If the comonomer is ethylene, then typically the comonomer-derived units comprise not in excess of about 15 wt % of the copolymer. The minimum amount of ethylene-derived units is typically at least about 3, preferably at least about 5 and more preferably at least about 9, wt % based upon the weight of the copolymer. If the polymer comprises at least one other comonomer other than ethylene, then the preferred composition would have a heat of fusion approximately in the range of a propylene-ethylene copolymer with about 3 to 20 wt. % ethylene.

The EPBPs of this invention can be made by any process, and includes copolymers made by CGC (Constrained Geometry Catalyst), metallocene, and nonmetallocene, metal-centered, heteroaryl ligand catalysis. These copolymers include random, block and graft copolymers although preferably the copolymers are of a random configuration. Exemplary propylene copolymers include Exxon-Mobil VISTAMAXX™ polymer, and VERSIFY™ propylene/ethylene elastomers and plastomers by The Dow Chemical Company.

The density of the propylene based elastomers or plastomers of this invention is typically at least about 0.850, can be at least about 0.860 and can also be at least about 0.865 grams per cubic centimeter (g/cm³) as measured by ASTM D-792. Preferably the density is less than about 0.89 g/cc. In general the lower the density, the lower the haze.

The weight average molecular weight (Mw) of the propylene based elastomers or plastomers of this invention can vary widely, but typically it is between about 10,000 and 1,000,000 (with the understanding that the only limit on the minimum or the maximum M, is that set by practical considerations). For homopolymers and copolymers used in the manufacture of peelable seals, preferably the minimum Mw is about 20,000, more preferably about 25,000.

The polydispersity of the elastomeric propylene based polymers of this invention is typically between about 2 and about 5. In general for low haze, it is preferred to use material with a narrow polydispersity. “Narrow polydispersity”, “narrow molecular weight distribution”, “narrow MWD” and similar terms mean a ratio (M_{w}/Mₙ) of weight average molecular weight (M_{w}) to number average molecular weight (Mₙ) of less than about 3.5, can be less than about 3.0, can also be less than about 2.8, can also be less than about 2.5.

The EPBPs for use in the first outer layer of the present invention ideally have an MFR of from 0.5 to 25 g/10 min, preferably from about 1 to 15, more preferably from about 2 to 10. MFR for copolymers of propylene and ethylene and/or one or more C₄-C₂₀ α-olefins is measured according to ASTM D-1238, condition L (2.16 kg, 230 degrees C.).

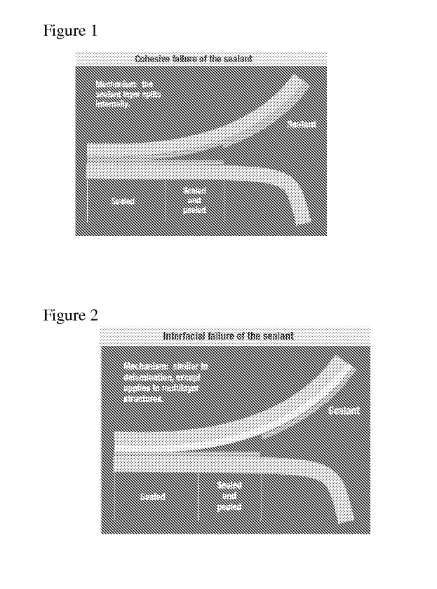

The multilayer films of the present invention further comprise an inner portion which is adjacent to the first outer layer. The inner portion may comprise a single layer or multiple layers, including microlayers. At least one layer of the inner portion comprises an EPBP as described above. Further at least one layer of the inner portion comprises a second polymer, wherein the second polymer is selected from the group consisting of high pressure low density polyethylene, high density polyethylene, ethylene acrylic acid copolymers, ethylene (meth) acrylic acid copolymers and combinations thereof. The second polymer may be together with the EPBP in the same layer or may be in a separate layer. Without being bound to any particular theory, it is believed that including the second polymer in the same layer as the EPBP results in a burst cohesive failure mechanism as depicted in FIG. 1 whereas including the second polymer in a separate layer results in a burst delaminating failure mechanism as depicted in FIG. 2.

The second polymer for use in the inner portion is selected from the group consisting of high pressure low density polyethylene, high density polyethylene, ethylene acrylic or (meth) acrylic acid copolymers and combinations thereof. The term “high pressure low density polyethylene” may also be referred to as “LDPE”, “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, herein incorporated by reference). It is preferred that the LDPE, if present, has a melt index (as determined according to ASTM D1238, 2.16 kg, 190° C.) of from 0.5 to 35 g/10 min, more preferably from 2 to 10 g/ 10 min, and a density (as determined according to ASTM D-792) of from 0.915 to 0.935 g/cm³, preferably from 9.915 to 0.930. The term “high density polyethylene” or “HDPE” for purposes of this invention indicates linear polyethylene having a density greater than 0.940 g/cm³. The preferred HDPE has a melt index of from 0.5 to 10 g/10 min, more preferably from 2 to 10 g/10 min. Ethylene acrylic copolymers (“EAA”) or ethylene (meth) acrylic acid copolymers (“EMAA”) refers to copolymers derived from ethylene acrylic acid or methacrylic acid, respectively. Preferred EAA or EMAA copolymers comprise from 3 to 20 percent by weight of units derived from the carboxylic acid copolymer. Suitable carboxyl-containing polymers include those sold under the trade name PRIMACOR™ by the Dow Chemical Company.

For the embodiments where the EPBP is blended with the second polymer in at least one layer, it is preferred that the EPBP comprise from 5 to 80 percent by weight of the layer, preferably from 30 to 80%, more preferably from 40 to 80%. It is preferred that the second polymer comprise from 10 to 95 percent by weight of the layer, preferably from 15 to 80%, more preferably from 20 to 60%. In some embodiments, it may be desirable to further include random copolymer polypropylene resin, preferably in an amount of from 30 to 70 percent by weight of the layer, more preferably from 40 to 70%, still more preferably from 50 to 70% and/or homopolymer polypropylene preferably in an amount of from 5 to 10 percent by weight of the layer.

For the embodiments where the EPBP and second polymer are in separate layers, it is preferred that each layer consists essentially of the pure EPBP or pure second polymer together with any additives. In such embodiments, no blending morphology to create immiscible phases is involved, and thus fluctuations from minor variations in the fabrication process are minimized. It is contemplated that the inner portion of the films of this embodiment of the present invention may comprise as few as two separate layers, but may also comprise a series of microlayers. “Microlayers” refers to sequences comprising a number, n, of repeating units, each repeating unit comprising at least two microlayers, (a) and (b), wherein one layer comprises PBPE and the other layer comprises the second polymer, such that the resulting structure has the formula [(a)(b)]ₙ. “n” is defined by the multiplicator feedblock of the microlayer extruder. The repeating microlayer sequence may also optionally contain one or more additional repeating layers layers (c), (d), etc., or a non-repeating layer commonly called an encapsulating layer. The overall thickness can be similar to classical blown or cast films, for example 25 to 200 microns. The ratios of the individual layers can be adjusted depending on the desired characteristics of the film but typically the ratios of A/B, A/C and B/C are in the range of from 0.2 to 0.8, and the ratio of the encapsulating layer (if present) to the repeating portion of the microlayer film is typically between 0.025 to 0.8. The multilayer films of the present invention further comprise a second outer layer arranged so that the inner portion is encapsulated between the first outer layer and the second outer layer. It should be understood that the term “encapsulate” as used herein refers to the planar surfaces; it is not necessary that that the edges of the inner portion are also encapsulated by the first outer layer and second outer layer.

The second outer layer comprises a third polymer, wherein said third polymer is selected from the group consisting of homopolymer polypropylene, random copolymer polypropylene and impact copolymer polypropylene and blends thereof. The preferences described for the first polymer are applicable for the third polymer, and in fact the third polymer may be the same as the first polymer. In general it is preferred that the MFR of the third polymer be from 0.5 to 35 g/10 min (as determined according to ASTM D1238, 2.16 kg, 230° C.), more preferably from 2 to 10 g/10 min. The particular MFR selected will depend in part on the intended fabrication methods such as blown film, extrusion coating, sheet extrusion, or cast film processes.

Optionally, the multilayered films of the present invention may contain one or more additional layers to provide additional functionality. For example layers comprising ethylene vinyl alcohol polymers or polyamide polymers may be added to provide additional structural stability and/or barrier properties.

It is preferred that the first outer layer has a thickness less than 30 microns, preferably less than 20 microns, more preferably 10 microns or less. The thickness of first outer layer determines force needed to initiate burst. Accordingly thinner films will require less force to initiate the burst. Once burst has been initiated, the film will be easy-opening, theoretically according to either the cohesive failure or delamination mechanism as described above. However, it should also be understood that thinner films will be more susceptible to damage during the retort process. Accordingly the first outer layer thickness should be optimized to achieve a proper balance of these properties.

It is preferred that the film have a total thickness of less than 200 microns, more preferably less than 150 microns.

### EXAMPLES

In order to demonstrate the utility of the present invention a series of multilayer films were made using the resins described in Table I

### Examples

TABLE I
Resins used in the examples)

| | | | Melt | | | Melting |
|---|---|---|---|---|---|---|
| | | | index* | Density | MFR** | Point |
| Resin | Description | Comonomer | (g/10 min) | (g/cm3) | (g/10 min) | (° C.) |
| A | Random | Ethylene | | 0.900 | 2 | 144 |
| | Copolymer | | | | | |
| | Polypropylene | | | | | |
| B | Impact | Ethylene | | 0.902 | 0.5 | 164 |
| | Copolymer | | | | | |
| | Polypropylene | | | | | |
| C | Impact | Ethylene | | 0.900 | 0.8 | 164 |
| | Copolymer | | | | | |
| | Polypropylene | | | | | |
| D | Homopolymer | None | | 0.900 | 2.1 | 164 |
| | Polypropylene | | | | | |
| E | High Pressure | None | 0.75 | 0.924 | | 112 |
| | LDPE | | | | | |
| F | High Pressure | None | 2 | 0.925 | | 114 |
| | LDPE | | | | | |
| G | High Pressure | None | 2 | 0.920 | | 110 |
| | LDPE | | | | | |
| H | PBPE | 9% wt | | 0.876 | 2 | 82 |
| | | Ethylene | | | | |
| I | PBPE | 5% wt | | 0.888 | 2 | 107 |
| | | Ethylene | | | | |

*at 190° C. under 2.16 kg
**at 230° C. under 2.16 kg

The following test methods are used to determine the values reported in Table 2:

Haze (%) is determined according to ASTM D1003-11

Heat Seal Initiation Temperature (HSIT) (° C.) is determined according to ASTMF2029-00 with a visual inspection of the resulting heat seal curve for the determination of temperature at which seal strength curve rises higher than 2 N/15 mm.

Burst peak Strength (N/15 mm) is determined according to ASTM F2029-00 with a visual inspection of the resulting seal curve, to determine the peak seal strength over full sealing temperature range.

Peel Plateau Strength (N/15mm) is determined according to ASTM F2029-00 with a visual inspection of the resulting seal curve, section of seal curve after (peak), determination of temperature range at which seal strength variation is less than 2N/15 mm over the range.

Seal Window (QC) is determined according to ASTM F2029-00 with a visual inspection of the resulting seal curve to determine the temperature range in which all seal strengths are higher than 2 N/15 mm.

TABLE II
Examples of A) - Encapsulated cohesive peel layer for a burst cohesive failure mechanism

| | Example 1 | Example 2 | Example 3 |
|---|---|---|---|
| Film Structure | A/B/C 70/20/10 | A/B/C 70/20/10 | A/B/C 70/20/10 |
| Film thickness (microns) | 100 | 100 | 100 |
| Layer A | 100% Resin A | 100% Resin A | 100% Resin A |
| Layer B | Compound: 50% Resin H + | Compound: 35% Resin A + | Compound: 33% Resin A + 2% Resin D + |
| | 50% Resin F | 15% Resin H + 50% Resin | 15% Resin H + 50% Resin F |
| | | F | |
| Layer C | 100% Resin A | 100% Resin A | 100% Resin A |
| Layer D | none | none | none |
| Layer E | none | none | none |
| Failure mode | Burst + Delaminating Failure | Burst + Delaminating Failure | Burst + Delaminating Failure |
| Haze before Retort(%) | 6 | 4 | 9 |
| Haze after Retort (%) | 16 | 13 | 15 |
| Seal properties before Retort: | | | |
| HSIT (° C.) | 130 | 130 | 130 |
| Burst peak Strength | 8-10N/15 mm | 7N/15 mm | 7N/15 mm |
| | 3-4 lb/in | 2.8 lb/in | 2.8 lb/in |
| Peel plateau Strength | 4N/15 mm | 2N/15 mm | 2N/15 mm |
| | 1.5 lb/in | 0.8 lb/in | 0.8 lb/in |
| Seal properties After Retort: | | | |
| HSIT (° C.) | 130 | 130 | 130 |
| Burst peak Strength (N/15 mm) | 8-10N/15 mm | 7N/15 mm | 7N/15 mm |
| | 3-4 lb/in | 2.8 lb/in | 2.8 lb/in |
| Peel plateau Strength (N/15 mm) | 4N/15 mm | 2N/15 mm | 2N/15 mm |
| | 1.5 lb/in | 0.8 lb/in | 0.8 lb/in |

| | Example 4 | Example 5 | Example 6 | Example 7 | Example 8 |
|---|---|---|---|---|---|
| Film Structure | A/A/B/A 35/35/20/10 | A/C/B/C 35/35/20/10 | A/A/B/A 35/35/20/10 | A/C/B/C 35/35/20/10 | A/C/B/C 35/35/20/10 |
| Film thickness (microns) | 100 | 100 | 100 | 100 | 100 |
| Layer A | 100% Resin A | 100% Resin A | 100% Resin A | 100% Resin A | 100% Resin A |
| Layer B | Compound: 35% | Compound: 35% | Compound: 35% | Compound: 35% | Compound: 55% |
| | Resin A, 45% Resin | Resin A, 45% Resin | Resin A, 35% Resin | Resin A, 50% | Resin A, 30% |
| | E, 15% Resin I, 5% | E, 15% Resin I, 5% | E, 15% Resin I, 15% | Resin E, 15% | Resin E, 15% |
| | Resin K | Resin K | Resin K | Resin I | Resin I |
| Layer C | none | 85% Resin A, | none | 95% Resin A, | 95% Resin A, |
| | | 15% Resin K | | 5% Resin J | 5% Resin J |
| Haze before Retort (%) | 3.67 | 28.6 | 4.27 | 3.45 | 4.02 |
| Haze after Retort (%) | 13.6 | 38.7 | 14.3 | 13 | 14.5 |
| Seal properties before Retort: | | | | | |
| HSIT (° C.) | 130 | 130 | 130 | 130 | 130 |
| Burst peak Strength | 7N/15 mm | 8N/15 mm | 12N/15 mm | 8N/15 mm | 10N/15 mm |
| | lb/in | lb/in | lb/in | lb/in | lb/in |
| Peel plateau Strength | 2N/15 mm | 2N/15 mm | 1N/15 mm | 2.5N/15 mm | 3N/15 mm |
| | lb/in | lb/in | lb/in | lb/in | lb/in |
| Seal properties After Retort: | | | | | |
| HSIT (° C.) | 130 | 130 | 130 | 130 | 130 |
| Burst peak Strength | 8N/15 mm | 9N/15 mm | 8.5N/15 mm | 9N/15 mm | 16N/15 mm |
| | lb/in | lb/in | lb/in | lb/in | lb/in |
| Peel plateau Strength | 1N/15 mm | 1.5N/15 mm | 1.5N/15 mm | 2N/15 mm | 3N/15 mm |
| | lb/in | lb/in | lb/in | lb/in | lb/in |

TABLE III
Examples of B) - Encapsulated delamination peel
layers for a burst delaminating failure mechanism

| | Example 9 | Example 10 |
|---|---|---|
| Film Structure | A/B/C/D/E | A/B/C/D/E |
| | 40/10/30/10/10 | 40/10/30/10/10 |
| Film thickness (microns) | 100 | 100 |
| Layer A | 100% Resin A | 100% Resin A |
| Layer B | 100% Resin I | 100% Resin H |
| Layer C | 100% Resin E | 100% Resin E |
| Layer D | 100% Resin I | 100% Resin H |
| Layer E | 100% Resin A | 100% Resin A |
| Failure mode | Burst + | Burst + |
| | Delaminating | Delaminating |
| | Failure | Failure |
| Haze before Retort (%) | 5 | 8 |
| Haze after Retort (%) | 16 | 20 |
| Seal properties before Retort: | | |
| HSIT (° C.) | 130 | 130 |
| Burst peak Strength | 8-10N/15 mm | 8-10N/15 mm |
| | 3-4 lb/in | 3-4 lb/in |
| Peel plateau Strength | 0.5N/15 mm | 1N/15 mm |
| | 0.2 lb/in | 0.4 lb/in |
| Seal properties After Retort: | | |
| HSIT (° C.) | 130 | 130 |
| Burst peak Strength | 8N/15 mm | 5N/15 mm |
| | 3 lb/in | 2 lb/in |
| Peel plateau Strength | 0.5N/15 mm | 0.5N/15 mm |
| | 0.2 lb/in | 0.2 lb/in |

1. A multilayer film comprising:
a. a first outer layer which is heat sealable, said first outer layer comprising from 95 to 100 percent by weight of the first outer layer of a first polymer, said first polymer being derived from propylene and optionally one or more comonomers selected from the group consisting of ethylene and C₄-C₈ alpha olefins, said first polymer having a melting point of at least 125° C.;
b. an inner portion adjacent to the first outer layer, said inner portion comprising (i) from 5 to 80 percent by weight of the inner portion of an elastomeric propylene based polymer; (ii) from 30 to 70 percent by weight of the inner portion of a random copolymer derived from propylene and one or more additional comonomers selected from the group consisting of ethylene, and C₄-C₈ alpha olefins; and (iii) from 20 to 60 percent by weight of the inner portion of a second polymer, wherein the second polymer is selected from the group consisting of high pressure low density polyethylene, high density polyethylene, ethylene acrylic acid copolymers, ethylene (meth) acrylic acid copolymers and combinations thereof;
c. optionally one or more additional layers; and
d. a second outer layer arranged so that the inner portion is encapsulated between the first outer layer and the second outer layer, said second outer layer comprising a third polymer, wherein said third polymer is selected from the group consisting of homopolymer polypropylene, random copolymer polypropylene and impact copolymer polypropylene and blends thereof.

2. The film of claim 1 wherein the inner portion comprises one or more discrete layers consisting essentially of the second polymer and one or more discrete layers consisting essentially of an elastomeric propylene based polymer.

3. The film of claim 2 wherein each of the discrete layers of the inner portion is part of a microlayer structure; where the term microlayer refers to sequences comprising a number, n, of repeating units, each repeating unit comprising at least two microlayers, (a) and (b), wherein one layer comprises the elastomeric propylene based polymer and the other layer comprises the second polymer.

4. The film of claim 1 wherein the inner portion comprises one or more layers comprising a blend of the second polymer and the elastomeric propylene based polymer.

5. (canceled)

6. The film of claim 1 wherein the inner portion further comprises:
a. from 5 to 10 percent by weight of the inner portion of a homopolypropylene.

7. The film of claim 5 wherein the elastomeric propylene based polymer has an MFR of from 2 to 25 g/10 min determined according to ASTM D1238 at 2.16 kg and at 230° C., and a density of from 0.850 to 0.890 g/cm³.

8. The film of claim 5 wherein the random copolymer has an MFR of from 0.5 to 5 g/10 min determined according to ASTM D1238 at 2.16 kg and at 230° C., and a density of from 0.90 to 0.902 g/cm³.

9. The film of claim 5 wherein the homopolypropylene has an MFR of from 0.5 to 10 g/10 min determined according to ASTM D1238 at 2.16 kg and at 230° C.

10. The film of claim 5 wherein the second polymer is a high pressure low density polyethylene and has an MI of from 0.5 to 35 g/10 min determined according to ASTM D1238 at 2.16 kg and at 190° C., and a density of from 0.915 to 0.932 g/cm³.

11. The film of claim 5 wherein the second polymer is a high density polyethylene and has an MI of from 0.5 to 10 g/10 min determined according to ASTM D1238 at 2.16 kg and at 190° C., and a density of from 0.94 to 0.96 g/cm³.

12. The film of claim 5 wherein the second polymer is an ethylene acrylic acid copolymer or an ethylene (meth)acrylic acid copolymer and has an MI of from 0.5 to 10 g/10 min determined according to ASTM D1238 at 2.16 kg and at 190° C., and a comonomer content of from 3 to 20 percent by weight of the ethylene acrylic acid copolymer or ethylene (meth)acrylic acid copolymer.

13. The film of claim 1 wherein the first outer layer further comprises from 0.1 to 5 percent by weight of the first outer layer, of an elastomeric propylene based polymer, which may be the same or different from the elastomeric propylene based polymer(s) used in the inner portion.

14. The film of claim 1 wherein the first polymer has an MFR of from 0.5 to 5 g/10 min determined according to ASTM D1238 at 2.16 kg and at 230° C., and a density of from 0.90 to 0.902 g/cm³.

15. The film of claim 1 wherein the third polymer has an MFR of from 0.5 to 5 g/10 min determined according to ASTM D1238 at 2.16 kg and at 230° C.

16. The film of claim 1 wherein the second outer layer further comprises a barrier structure comprised of ethyl vinyl alcohol or a polyamide.

17. The film of claim 15 wherein the barrier structure is coextruded as a separate layer.

18. The film of claim 1 wherein the film further comprises one or more non-surface layers in addition to the inner portion.

19. The film of claim 1 wherein the first polymer is a polypropylene.

20. The film of claim 18 for use in retort applications.
